(19) United States
(12) Patent Application Publication
(10) Pub. No.: US 2006/0050876 A1
(43) Pub. Date: Mar. 9, 2006

(54) Integrated circuit with coded security signal, security process, corresponding security device and signal coded using a dynamic key

(75) Inventor: Karl Courtel, Reze (FR)

Correspondence Address: WESTMAN CHAMPLIN & KELLY, P.A., SUITE 1400 - INTERNATIONAL CENTRE, 900 SECOND AVENUE SOUTH, MINNEAPOLIS, MN, 55402-3319, US

(73) Assignee: Atmel Nantes SA, Nantes Cedex (FR)

(21) Appl. No.: 11/201,060

(22) Filed: Aug. 10, 2005

(30) Foreign Application Priority Data
Sep. 3, 2004 (FR) 04/09370

(51) Int. Cl. H04L 9/00

(52) U.S. Cl. 380/44

(57) ABSTRACT

An integrated circuit is provided, which comprises at least one security module, controlled by at least one security signal, the circuit being made at least partially inoperable if the security module receives at least one of the said security signal(s) with a predetermined value. Such a circuit comprises means for encoding the security signal using a dynamic key, receiving a static security signal and outputting a dynamic security signal, and means to transmit the dynamic key or at least one item of information representative of the dynamic key to the security module.

### CROSS-REFERENCE TO RELATED APPLICATION

The present application claims priority of French Application No. FR 04/09370, filed Sep. 3, 2004, not in English.

### FIELD OF THE INVENTION

This invention relates to the field of electronic systems. The invention particularly relates to integrated circuits, for example “chips” on smart cards or systems on chips.

More precisely, the invention relates to the security of information and particularly protection information for such electronic systems.

### BACKGROUND OF THE INVENTION

In many electronic systems, it is necessary to protect information derived from configurations or physical parameters.

Some information must remain unchangeable, particularly in the case of smart cards. Similarly, it must be impossible to modify some configurations by an intrusion operation. In the case of integrated circuits comprising a software part, it is sometimes necessary for this software part to be accessible and/or modifiable by the system vendor, so as to configure the circuit. However, once this configuration has been made, the software part frequently has to remain fixed and inaccessible by the future buyer and all other third parties.

There are security mechanisms that can be activated by static security information (less than one variation per minute) so as to prevent a user from access, modification or any other unauthorised operation on information in an electronic system. This security information is carried by signals that are themselves static. The security mechanisms restrict access or use of the system and possibly make the electrical system temporarily or permanently inoperable if an unauthorised operation is performed.

For example, according to one simple security mechanism based on a single security bit, the system operates normally if the static security level is zero. However, it becomes impossible to access the system program memory in read if the security level changes from 0 to 1.

These security levels can be configured by fuses or programmable bits output from ROM, EPROM, FLASH, EEPROM or MRAM memory points.

These memory points are usually associated with memory blocks (or more generally any “hard block”, in other words a block comprising regular easily identifiable patterns) of systems in order to share analogue resources necessary for their correct operation (charge pump, voltage reference, etc.).

The result is that static security signals carrying static security information for the electronic system are sent by these hard blocks (particularly including memory points and/or sensors) that are easily identifiable on silicon due to their size and regular structure.

FIG. 1 shows a diagram of an integrated circuit 10 comprising a simple security mechanism like that shown in the above mentioned example. The system 10 comprises a hard block 11, a signal routing block 12 and a security module 16 embedded in the routing area. A static security signal is transmitted using a line 15 included in the routine block from the hard block 11 to the security module 16 (embedded in the routing area) that restricts use of the circuit 10 if a system protection (characterised by the security information changing from level 0 to level 1 or vice versa) is used.

The routing block 12 includes a large quantity of interlaced circuit lines such that it is only possible to identify and follow a line in this block, and particularly line 15, along a few microns, and only starting from the hard block 11;
Easily identifiable interfaces 13 interconnect the memory block 11 and the routing block 12. Static output security signals can be pirated in an area 121 called the “exposed” area (a few microns long) in the routing block at the interfaces 13.

A “pirate” user can then place a metal probe 14 on the beginning of the line 15 (in area 121) carrying the static security signal output from the hard block 11. He can then force the security signal (to 0 in the above mentioned example) to inhibit one of the protections of the circuit 10 (restricted access to the system in the example mentioned). Placement of a probe 14 in this way allows a pirate user to perform an unauthorised operation that will not be detectable by the security module 16.

Another pirating technique, not shown, may consist of partial destruction of line 15 using a laser, or by scratching, to make a node at the end of the line 15 floating and thus alter the value of the security level 1 in the example mentioned above.

### SUMMARY OF THE INVENTION

One particular purpose of an embodiment of the invention is to overcome these disadvantages according to prior art.

More precisely, one purpose of an embodiment of the invention is to provide a technique for protecting security mechanisms of an electronic system from pirating.

Another purpose of an embodiment of the invention is to implement such a technique that prevents forcing of a static security level, particularly by placing a probe on a line or destruction of a line.

Another purpose of the invention is to provide such a technique that is easy to use, that only occupies a small area of silicon, that is inexpensive and does not require any additional process step.

These objectives, and others that will become clear later, are achieved, for example, using an integrated circuit comprising at least one security module, controlled by at least one security signal, the system being made at least partially inoperable if the security module receives at least one security signal with a predetermined value.

According to an embodiment of the invention, such a circuit comprises means of encoding the security signal using a dynamic key, receiving a static security signal and outputting a dynamic security signal, and means of transmission of the dynamic key or at least one item of information representative of the dynamic key, to the security module.

Thus, an embodiment of the invention is based on a quite innovative and inventive approach to the security process in which dynamic encoding of security signals can protect static security signals of the electronic system from being pirated.

According to one embodiment of the invention, the coded security signal and the dynamic key or the information representative of the dynamic key are transferred using at least two physically adjacent electrically conducting elements.

Thus, several metal probes are necessary to force a time coded security signal (one to force the security signal and one or more for acquisition of information representative of the key).

Advantageously, the spacing between conducting elements is defined so that it is impossible to simultaneously place distinct metal probes on each conducting element in at least one accessible area called the exposed area.

Thus, the choice of a small spacing between electrical lines in the exposed area can physically prevent simultaneous placement of all metal probes necessary for pirating by forcing security levels.

According to one preferred characteristic of the invention, the conducting elements are distributed on at least two distinct routing levels.

Preferably, the integrated circuit uses at least two distinct security signals and generates a distinct dynamic key for each security signal.

According to one advantageous embodiment of the invention, the integrated circuit uses means of composition of the dynamic key making use of n bits of an intermediate key, where n is a non-zero natural integer.

Advantageously, the composition means of the dynamic key use a first exclusive OR gate applied on the bits of the intermediate key.

Preferably, the encoding means use a second exclusive OR gate applied on the static security signal and the dynamic key.

According to one advantageous characteristic of the invention, the encoding means take account of at least one dynamic data output by a pseudo-random generator and/or a counter with p bits, where p is a non-zero natural integer.

According to one advantageous embodiment, at least one security signal is output by a hard block.

Preferably, the hard block belongs to the group comprising:
ROM memories;
EPROM memories;
FLASH memories;
EEPROM memories;
MRAM memories;
depassivation sensors;
chemical etching sensors;
opening sensors;
light sensors;
voltage sensors;
frequency sensors.

According to one advantageous embodiment of the invention, the integrated circuit is at least partly protected by a metallisation.

Preferably, the metallisation covers at least the encoding means, the generation means and/or at least part of the hard block.

According to one advantageous characteristic of the invention, the security module includes decoding means using processing approximately symmetric with the encoding processing.

Advantageously, the static security signal is a binary signal.

According to one preferred embodiment of the invention, it uses means of doubling up at least one of the intermediate keys into a primary intermediate key and a secondary intermediate key correlated to each other, and electrical isolation means between the primary intermediate key and the secondary intermediate key.

The integrated circuit preferably includes:
means of stabilising the decoded security signal using at least one flip-flop;
means of detecting the presence of at least one front on the decoded signal;
means of blocking the integrated circuit, if the decoded signal comprises at least one front.

An embodiment of the invention also relates to a security process for an integrated circuit comprising at least one security module controlled by at least one security signal, the circuit being made at least partially non-operable if the security module receives at least one security signal with a predetermined value, the security process including a step to code the security signal using a dynamic key and a step to transmit the dynamic key or at least one item of information representative of the dynamic key to the security module.

Advantageously, the said coded security signal and the said dynamic key or the said information representative of the said dynamic key are transferred using at least two adjacent electrically conducting elements.

Preferably, the spacing between the said conducting elements is defined so that it is impossible to simultaneously place separate metal probes on each of the said conductors in at least one accessible area called the exposed area.

The advantages of the security process are the same as the advantages of the integrated circuit described above and they are not described in more detail.

An embodiment of the invention also relates to a security device for an integrated circuit like that described above.

An embodiment of the invention also relates to a security signal like that described above.

### BRIEF DESCRIPTION OF THE DRAWINGS

Other characteristics and advantages of the invention will become clear after reading the following description of a preferred embodiment given as a simple illustrative and non-limitative example and the attached drawings among which:

FIG. 1 shows a diagram of an integrated circuit comprising a simple security mechanism according to prior art;

FIG. 2 shows an embodiment of encoding means according to the invention for a binary static security signal in the integrated circuit in FIG. 1;

FIG. 3 shows a physical embodiment of the means according to an embodiment of the invention for transmission of the dynamic signal in the circuit in FIG. 2 towards a security module in an integrated circuit;

FIG. 4 shows an integrated circuit according to an embodiment of the invention using three security signals.

### DETAILED DESCRIPTION OF ILLUSTRATIVE EMBODIMENTS

The general principle of an embodiment of the invention is based on encoding using a dynamic key, advantageously dependent on the bits of a secondary intermediate key, a static security signal forming part of a security process of an electronic system. It is also based on transmission of this coded signal from a hard block and the bits of a primary intermediate key from a bit generator to a security module embedded in a routing block by electrical lines.

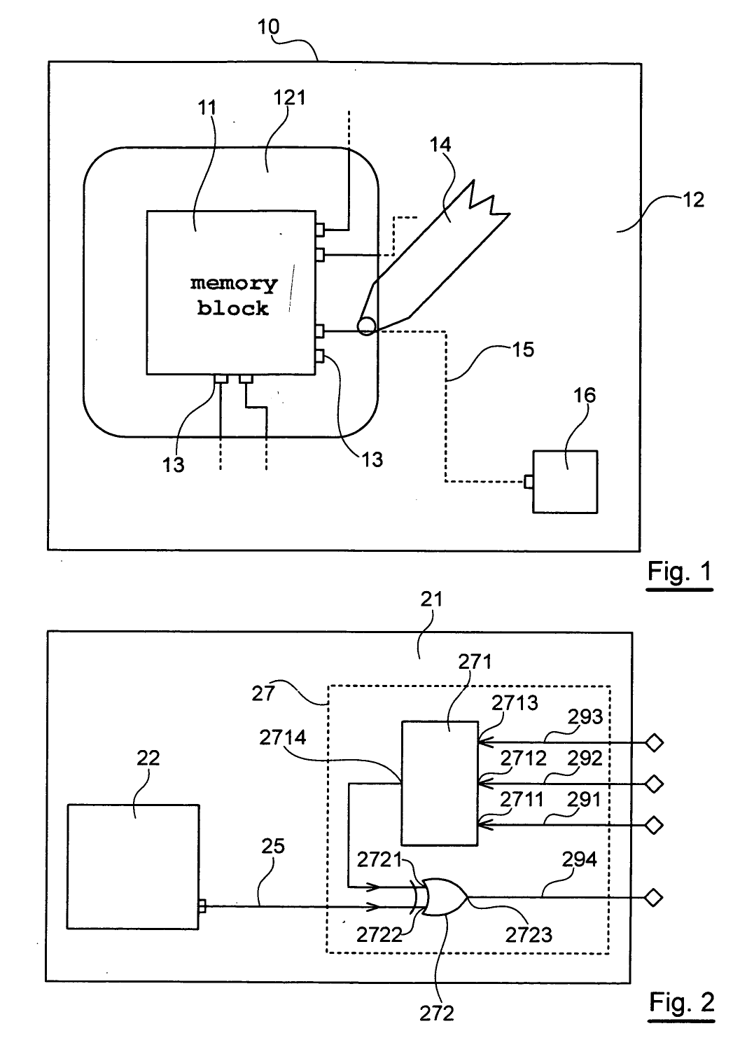

Unless mentioned otherwise, the following description relates to an integrated circuit such as the integrated circuit 10 described in FIG. 1, which also implements the technique according to an embodiment of the invention. For example, it may be the processor of a smart card.

We will now describe a preferred embodiment of the encoding means or circuit 27 of a binary static security signal included in a hard block 21 according to an embodiment of the invention, with reference to FIG. 2. The hard block 21 comprises a memory (or check) point 22 that outputs the static security signal on an electrical line 25 located in the hard block 21.

The hard block 21 may at least partly comprise at least one of the following functions:
ROM memories;
EPROM memories;
FLASH memories;
EEPROM memories;
MRAM memories;
depassivation sensors;
chemical etching sensors;
opening sensors;
light sensors;
voltage sensors;
frequency sensors.

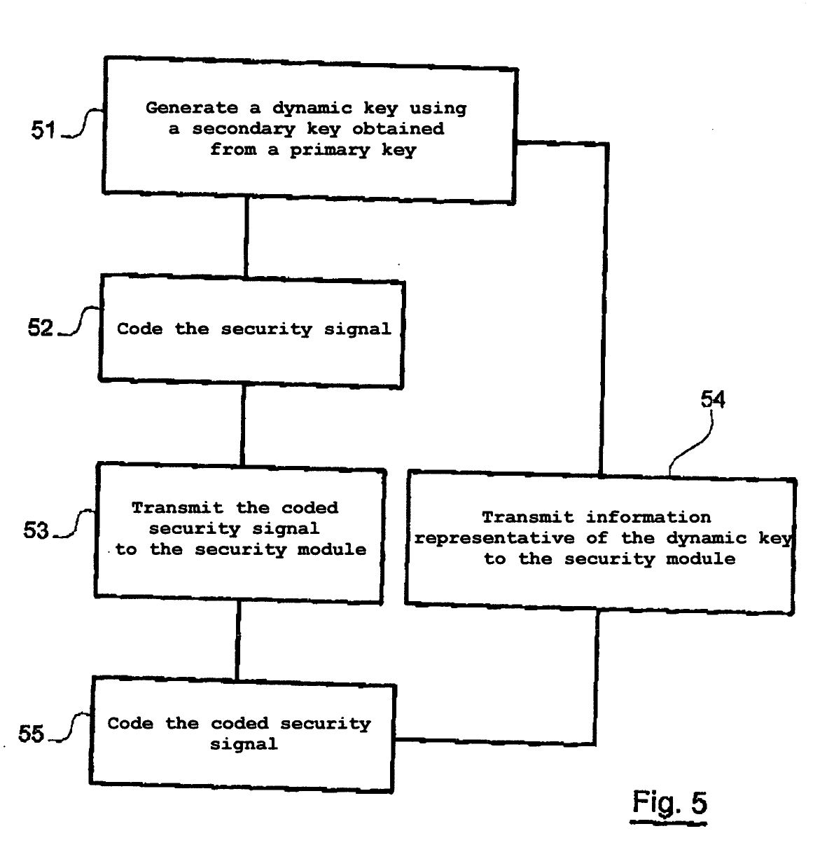

The encoding means comprise a first exclusive OR gate 271, for which the inputs 2711, 2712, 2713 are connected to three electrical lines 291, 292, 293 respectively, carrying a first dynamic bit denoted as key[0], a second dynamic bit key[1] and a third dynamic bit key[2] respectively, forming a secondary intermediate key (described below with reference to FIG. 4). Thus, the first gate is used to compose a dynamic key by application of the exclusive OR function on the bits key [0], key[1], key[2] of the secondary intermediate key. Output 2714 from this first gate 271 carrying the dynamic key is connected to a first input 2721 to a second exclusive OR gate 272. The electrical line 25 connected to a second input 2722 to the second gate 272 is used to input the static security signal to this second gate 272.

Obviously, according to variants of this embodiment, not shown, the hard block 21 may use a secondary intermediate key comprising another number of dynamic bits and therefore a first OR gate 271 comprising a number of inputs equal to the number of bits used. According to other variants, the encoding means may use another number of exclusive OR gates. Furthermore, combinations other than an exclusive OR may be considered.

The second gate 272 outputs at output 2723 the coded security signal, also called the dynamic security signal, on a line 294.

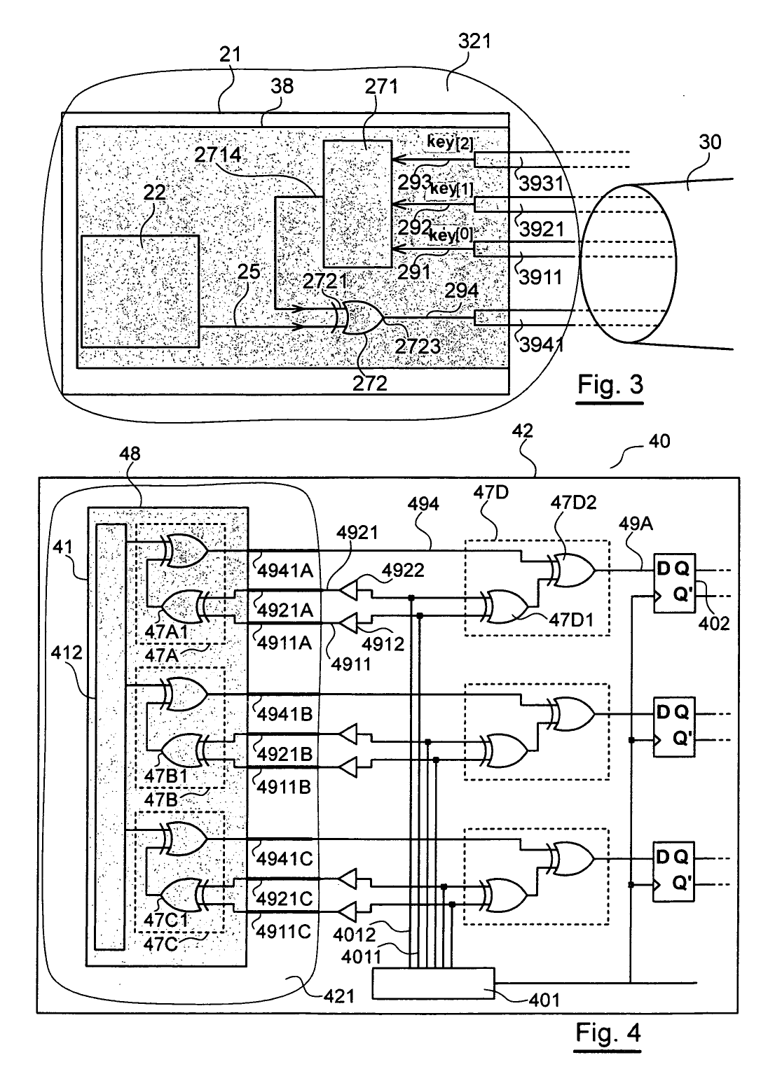

FIG. 3 shows means of transmission of the dynamic signal in the hard block 21 in FIG. 2 to a security module (not shown in this FIG. 3) in the integrated circuit.

A metal layer 38 protects a part of the circuit from pirating attempts, attempting to access the security signal (particularly by forcing or partial destruction). This layer 38 covers particularly:
the memory point 22, the electrical line 25 transmitting the static security signal;
the electrical line connecting the output 2714 from the first gate 271 to the input 2721 to the second gate 272 carrying the dynamic key;
a part of lines 291, 292 and 293 carrying the dynamic bits key[0], key[1], key[2] of the secondary intermediate key, at the input to the first gate 271;
a part of the electrical line 294 carrying the dynamic security signal at the output from the second gate 272;
the first and second gates 271, 272.

The metal layer 38 may be made of aluminium, copper or any other appropriate material or alloy.

Thus, part of the electrical lines 291, 292, 293, 294 carrying the three dynamic bits key[0], key[1], key[2] respectively of the secondary intermediate key and the dynamic security signal located in the exposed area 321 of the routing block (not shown) of the circuit is not covered by the metal layer 38. Pirating attempts may be made particularly in this uncovered part of the exposed area.

Consequently, the parts 3911, 3921, 3931, 3941 of these electrical lines 291, 292, 293, 294 located in the exposed area 321 (and possibly in the remainder of the routing block) that are not covered by the metal layer 38 are made so that they are sufficiently close, so that it is impossible to use metal probes 30 to access each of the bits key[0], key[1], key[2] in the secondary intermediate key and the dynamic security signal simultaneously.

According to variants of this embodiment, not shown, the parts of the electrical lines 3911, 3921, 3931, 3941 are distributed on several distinct stacked routing levels.

FIG. 4 shows an integrated circuit 40 using three security signals according to a preferred embodiment of the invention.

According to variants of this example embodiment of the invention, not shown, the circuit 40 may comprise an arbitrary number of security signals.

The integrated circuit 40 comprises a hard block 41 and a routing block 42 positioned around the hard block 41. The hard block 41 comprises a memory block 412 from which three static security signals are output, coded using three encoding devices 47A, 47B, 47C, all three being identical to the encoding means 27 in FIG. 2 except that each of their first exclusive OR gates 47A1, 47B1, 47C1 only comprises two inputs. As described below, there is a second distinct secondary intermediate key corresponding to each of these gates for which the two dynamic bits are applied on the two inputs.

The dynamic keys of the security signals are distinct so as to assure that a user attempting to implement an unauthorised operation in the circuit 40 (or to force the circuit 40), is unable to deduce the value to be imposed on a coded security signal by observing changes in another coded security signal.

A metal layer 48 covers the memory block 412, a part of the electrical lines and the encoding devices 47A, 47B, 47C (in the same way as the layer 38 in FIG. 3) so as to only leave the following uncovered in the exposed area 421:
parts 4941A, 4941B, 4941C of the electrical lines carrying the three coded security signals and
parts 4911A, 4921A, 4911B, 4921B, 4911C, 4921C of the electrical lines carrying the 3 pairs of bits of the secondary intermediate keys.

Since the processing and transmission means (encoding, transmission and decoding described below) are identical for each of the 3 security signals, we will only consider one of these signals in the following, denoted the security signal, for simplification purposes.

The static security signal is transmitted to the encoding device 47A associated with it and is coded using a dynamic key obtained by applying the first gate 47A1 to the two bits of a secondary intermediate key, as shown in FIG. 2.

In one preferred embodiment, the bits in the secondary intermediate key are binary signals that vary at random in time. The following describes how these signals may be obtained.

According to one preferred embodiment of the invention, two dynamic one-bit signals are generated using a simple pseudo-random bit generation using a prime polynomial implemented using a Linear Feedback Shift Register 401, or even using a counting device. These two dynamic bits form a primary intermediate key.

The dynamic bits of this primary intermediate key are carried on two electrical lines 4011, 4012 connected to electrical lines 4911 and 4921.

The result is thus an intermediate encoding key called the secondary intermediate key that is transmitted to the encoding device 47A, and an intermediate decoding key called the primary intermediate key that is transmitted to a decoding device 47D. The bits of the secondary intermediate key are made electrically independent of the bits of the primary intermediate key by means of two buffer circuits 4912 and 4922 placed on the electrical lines 4011 and 4012 respectively. With these two buffer circuits 4912 and 4922, the dynamic bits of the primary intermediate key can be duplicated so as to form primary dynamic bits and secondary dynamic bits.

The coded security signal and the two bits of the primary intermediate key are transmitted to the decoding device 47D using three electrical lines 494, 4011, 4012.

The exposed parts 4941A, 4911A, 4921A of the electrical lines 494, 4911, 4921 carry the coded security signal and the bits of the secondary intermediate key (on the encoding side) respectively, and are made such that they are sufficiently close so that it is impossible to access each of the two bits in the secondary intermediate key and the dynamic security signal at the same time using metal probes.

The security signal is decoded based on a processing approximately symmetrical with the encoding processing. Thus, the decoding device 47D itself also includes a first exclusive OR gate 47D1 and a second exclusive OR gate 47D2. The dynamic key can be obtained by applying the two bits of the primary intermediate key to the first gate 47D1, and then the dynamic key and the coded security signal can be applied to the second gate 47D2 to restore the static security signal on output 49A from the decoding device 47D.

A flip-flop 402 is placed at the output 49A that stabilises the value of the output signal output from the second gate 47D2 that must be equal to the static value of the static security signal if no pirating attempt has been made.

The output from the flip-flop 402 is connected to one or several control modules not shown in FIG. 4. This or these control modules comprise means of detecting whether or not there are any fronts on the output signal. Detection of a given number of fronts on the output signal within a determined time interval will cause temporary or permanent inoperability of the integrated circuit 40.

It should be noted that the part of the routing block 42 outside the exposed area 421, and particularly the parts concerned of the electrical lines 4911, 4921, 494, 4011, 4012, the decoding device 47D, the flip-flop 402 and the control module(s), are not protected by metallisation since it is impossible to identify them among the large number of interlaced circuit lines in the routing block 42.

However, according to one variant of this embodiment, not shown, the integrated circuit 40 may be entirely covered by the metal layer 48.

Obviously, the invention is not limited to the example embodiments mentioned above.

In particular, those skilled in the art may make any variant to the encoding and/or decoding means of the integrated circuit according to the invention, or for example to the means of composition of the dynamic key. For example, he can use a single exclusive OR gate applied both to the static security signal and to the bits of the intermediate key or even to choose other types of logic gates so as to make the encoding and/or decoding, or he can also use other appropriate techniques for encoding and/or decoding.

Similarly, in some variants, he can use a decoding device different from the encoding device.

An example embodiment of the invention is also applicable to a security process used in the integrated circuit 40 described above with reference to FIG. 4.

This specific process shown in FIG. 5 comprises the following steps:
a first step 51 to generate a dynamic key using a secondary intermediate key obtained from a primary intermediate key;
a second step 52 encoding the static security signal using the dynamic key;
a third step 53 transmitting the coded security signal to the security module;
a fourth step 54 used in parallel with the first step 51, to transmit the dynamic key or at least one item of information representative of the dynamic key to the security module;
a fifth step 55 to decode the security signal coded using the intermediate primary key.

Obviously, at least one embodiment of the invention is also applicable to a security device for an integrated circuit like that described above, comprising means of encoding, transmitting and decoding at least one security signal for the integrated circuit.

An embodiment of the invention is also applicable to security signals like those described above.

What is claimed is:

1. An integrated circuit comprising:
at least one security module, controlled by at least one security signal, the said circuit being made at least partially inoperable if the security module receives at least one of the said security signal(s) with a predetermined value;
means of encoding the said security signal using a dynamic key, receiving a static security signal and outputting a dynamic security signal; and
means of transmitting the said dynamic key or at least one item of information representative of the said dynamic key, to the security module.

2. The integrated circuit according to claim 1, wherein the said encoded security signal and the said dynamic key and/or the said information representative of the said dynamic key are transferred using at least two physically adjacent electrically conducting elements.

3. The integrated circuit according to claim 2, wherein the spacing between the said conducting elements is defined so that it is impossible to simultaneously place distinct metal probes on each of the said conducting elements in at least one accessible area called an exposed area.

4. The integrated circuit according to claim 2, wherein the said conducting elements are distributed on at least two distinct routing levels.

5. The integrated circuit according to claim 1, wherein the integrated circuit uses at least two distinct security signals and generates a distinct dynamic key for each of the said security signals.

6. The integrated circuit according to claim 1, wherein the integrated circuit uses means of composition of the said dynamic key, making use of n bits of an intermediate key, where n is a non-zero natural integer.

7. The integrated circuit according to claim 6, wherein the said composition means of the said dynamic key use a first exclusive OR gate applied on the said bits of the intermediate key.

8. The integrated circuit according to claim 7, wherein the said encoding means use a second exclusive OR gate applied on the said static security signal and the said dynamic key.

9. The integrated circuit according to claim 1, wherein the said encoding means take account of at least one dynamic data output by a pseudo-random generator and/or a counter with p bits, where p is a non-zero natural integer.

10. The integrated circuit according to claim 1, wherein at least one of the said security signals is output by a hard block.

11. The integrated circuit according to claim 10, wherein the said hard block belongs to the groupconsisting of:
ROM memories;
EPROM memories;
FLASH memories;
EEPROM memories;
MRAM memories;
depassivation sensors;
chemical etching sensors;
opening sensors;
light sensors;
voltage sensors; and
frequency sensors.

12. The integrated circuit according to claim 1, wherein the integrated circuit is at least partly protected by a metallisation.

13. The integrated circuit according to claim 12, wherein at least one of the said security signals is output by a hard block, the said encoding means take account of at least one dynamic data output by a generation means, and the said metallisation covers at least the said encoding means, the said generation means and/or at least part of the hard block.

14. The integrated circuit according to claim 1, wherein the security module includes decoding means using processing approximately symmetric with that of the encodingmeans.

15. The integrated circuit according to claim 1, wherein the said static security signal is a binary signal.

16. The integrated circuit according to claim 6, wherein the integrated circuit comprises means of doubling up at least one of the said intermediate keys into a primary intermediate key and a secondary intermediate key correlated to each other, and electrical isolation means between the said primary intermediate key and the said secondary intermediate key.

17. The integrated circuit according to claim 1 and further comprising:
means for decoding the said at least one security signal;
means of stabilising the said decoded security signal using at least one flip-flop;
means of detecting the presence of at least one front on the said decoded security signal; and
means of blocking the said integrated circuit, if the said decoded security signal comprises at least one front.

18. A security process for an integrated circuit comprising at least one security module, comprising:
coding at least one security signal using a dynamic key;
transmitting the dynamic key or at least one item of information representative of the said dynamic key to the said security module;
controlling the said security module by the said at least one security signal; and
making the integrated circuit at least partially non-operable if the said security module receives at least one of the said security signal(s) with a predetermined value.

19. The security process according to claim 18, wherein the said coded security signal and the said dynamic key or the said information representative of the said dynamic key are transferred using at least two adjacent electrically conducting elements.

20. The security process according to claim 19, wherein the spacing between the said conducting elements is defined so that it is impossible to simultaneously place separate metal probes on each of the said conducting elements in at least one accessible area called an exposed area.

21. A security device for an integrated circuit, the said device comprising:
at least one security module, controlled by at least one security signal, the said circuit being made at least partially inoperable if the said security module receives at least one of the said security signal(s) with a predetermined value;
means of encoding the said security signal using a dynamic key, receiving a static security signal and outputting a dynamic security signal; and
means of transmitting the said dynamic key or at least one item of information representative of the said dynamic key, to the said security module.

22. A security signal for an integrated circuit controlling at least a security module of the said circuit, the said circuit being made at least partially non-operable if the said security module receives the said security signal with a predetermined value, wherein the security signal is coded using a dynamic key, and the said dynamic key or at least one item of information representative of the said dynamic key is transmitted to the said security module.
